(19) United States
(12) Patent Application Publication
(10) Pub. No.: US 2009/0150267 A1
(43) Pub. Date: Jun. 11, 2009

(54) SYSTEM AND METHOD FOR MONITORING THE STATUS OF ITEMS SUBJECT TO LIENS

(76) Inventors: Stuart Sherman, North York (CA); Derek Ratcliffe, North York (CA)

Correspondence Address: CURTIS, MALLET-PREVOST, COLT & MOSLE, LLP, 101 PARK AVENUE, 34TH FLOOR, NEW YORK, NY, 10178-0061, US

(21) Appl. No.: 12/330,094

(22) Filed: Dec. 8, 2008

Related U.S. Application Data
(60) Provisional application No. 60/996,826, filed on Dec. 6, 2007.

(51) Int. Cl. G06Q 40/00; G06Q 10/00; G06F 17/30; G06F 7/10; G06Q 50/00

(52) U.S. Cl. 705/30; 705/38; 707/10; 707/3; 707/E17.005; 707/E17.014

(57) ABSTRACT

A computer-implemented system and method for monitoring the status of an item subject to a lien, comprising receiving registration information associated with the item subject to the lien, including at least one identifier uniquely associated with the item. The registration information is stored in a record associated with the item within an item database. Data about the item is received over a communications network from at least one information source based on the unique identifier associated with the item. The received data is compared to the stored registration information to determine whether the status of the item has changed. The database record is updated to reflect a change in status of the item and a notification is automatically generated to a holder of the lien when the status of the item has changed.

### CROSS-REFERENCE TO RELATED APPLICATIONS

This application claims the benefit of U.S. Provisional Patent Application No. 60/996,826, filed Dec. 6, 2007, the entire disclosure of which is incorporated by reference herein.

### FIELD

This application relates to an automated system and method for monitoring the status of items subject to liens.

### BACKGROUND

Many purchases made by individuals or organizations of expensive items, such as, for example, vehicles, property, industrial equipment, etc., are financed through loans from a lender (e.g., a bank). The lender establishes a lien or security interest in the purchased item, which may allow the item to be reclaimed and sold by the lender if the purchaser fails to pay back the lender according to the terms of the loan. The type of lien or security interest established may depend on the jurisdiction in which the sale takes place.

In some jurisdictions, and for some items, the lien or security interest may be separate from the title or registration of ownership for the item. Information about the lien or security interest established in an item may be kept separate from information about the holder of the title to or registered owner of the item. For example, in Canada, when a vehicle purchase is financed, the lender may establish a security interest in the vehicle under the Personal Property Security Act (“PPSA”) with a Conditional Sale Contract. Information about the PPSA security interest may be known only to the lender and the purchaser, as checking the status of a lien with the appropriate governmental authority may be convoluted and difficult for the unsophisticated. The purchaser of the vehicle may register ownership of the vehicle with a Provincial Ministry of Transportation (“PMT”), where the purchaser may receive a registration of ownership document. The PMT may not be informed about the security interest in the vehicle and may, therefore, not have any records indicating that the lender is still owed payment for the vehicle from the purchaser.

In situations where the title or registration of ownership for an item is separate from information about any liens or security interests in the item, it may become possible for the item to be sold out of trust, allowing the purchaser to defraud the lender. The purchaser may sell the item to a second purchaser and transfer the title or registration of ownership to the second purchaser without notifying the lender. If the purchaser then stops making payments to the lender on the loan used to purchase the item, the lender may attempt to recover the item based on the lender's security interest in the item. However, because the purchaser no longer has the item, the lender may have to attempt to recover the item from the second purchaser. If the second purchaser is a bona fide purchaser for value without notice (i.e., had no notice that the purchaser was defrauding the lender, and paid a fair price to the purchaser) in a jurisdiction that recognizes such a concept, the lender may be unable to recover the item unless they are able to take action to reverse the sale immediately. If too much time has passed after the sale of the item to the second purchaser, the lender may be unable to recover the item from the second purchaser. The lender may also attempt to recover money or assets from the purchaser as repayment for the loan. If the purchaser has declared bankruptcy, the lender may be unable to recover enough money from the purchaser to cover repayment of the loan and, in some cases, the lender may be unable to recover any money at all. Unable to recover the item, money or assets from the purchaser, the lender may be unable to recoup the money loaned to the purchaser.

For example, in Canada, the purchaser of a vehicle may sell the vehicle to a second purchaser, who may be a bona fine purchaser without notice. The purchaser may go to the PMT and claim a lost ownership, and receive a second registration of ownership document. The second registration of ownership document may be transferred to the second purchaser, while the purchaser keeps the original registration of ownership document. The Conditional Sales Contract between the purchaser and lender may state that should the purchaser sell the vehicle, the purchaser would owe a balloon payment of the amount remaining on the loan to the lender. Because the PMT has no access to lien or security interest information, the lender may not be notified of the sale, and may not request the balloon payment from the purchaser. The purchaser may still have the original registration of ownership document, making it more difficult for the lender to discover the sale through a paper audit, which may be the type of audit conducted by lenders, for example, lenders to third party leasing companies. If the purchaser stops paying the lender on the loan, the lender may attempt to recover the vehicle, only to find that the purchaser no longer has possession of the vehicle. The lender may be unable to recover the vehicle from the second purchaser because of Canadian protection for bona fide purchasers for value without notice, unless the lender had discovered the sale out of trust and taken immediate action to reverse the sale. Attempts to recover money or assets from the purchaser may fail if the purchaser has declared bankruptcy. The lender may have to take a loss on the unpaid balance of the loan.

### BRIEF SUMMARY

In one aspect of this disclosure, a computer-implemented system and method is disclosed for monitoring the status of an item subject to a lien, comprising receiving registration information associated with the item subject to the lien, including at least one identifier uniquely associated with the item. The registration information is stored in a record associated with the item within an item database. Data about the item is received over a communications network from at least one information source based on the unique identifier associated with the item. The received data is compared to the stored registration information to determine whether the status of the item has changed. The database record is updated to reflect a change in status of the item and a notification is automatically generated to a holder of the lien when the status of the item has changed.

The foregoing has outlined generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

A more complete understanding of this application can be obtained when the following detailed description is considered in conjunction with the following drawings, in which:

FIG. 1 is a schematic of an illustrative computer system for monitoring the status of items subject to liens;

FIG. 2 is a block diagram illustrating a preferred network for monitoring the status of items subject to liens;

FIG. 3 is a flowchart illustrating a preferred sequence of steps for monitoring the status of items subject to liens.

FIG. 4 is a block diagram illustrating a network arrangement allowing a port management facility to restrict items subject to liens from being shipped overseas;

FIG. 5 is a block diagram illustrating a network arrangement allowing a bailiff/third party to identify automobiles that are uninsured or whose owner is in default in payment of a loan secured by the vehicle; and

FIG. 6 is a block diagram illustrating a network arrangement allowing a police officer to confirm insurance status of an automobile during a traffic stop.

### DETAILED DESCRIPTION

A preferred system and method for monitoring the status of items subject to liens are disclosed herein. While specific configurations and arrangements are described below, it should be understood that this is done for illustrative purposes only. A person skilled in the relevant art will recognize that other configurations and arrangements can be used without departing from the spirit and scope of the invention. It will also be apparent to a person skilled in the relevant art that this invention can also be employed in a variety of other systems and applications. All examples herein are exemplary and non-limiting.

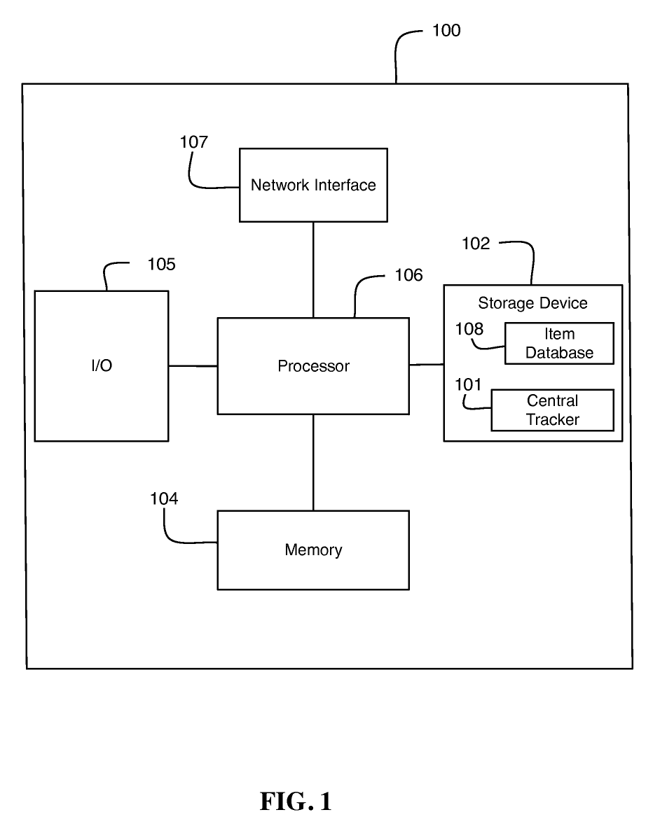

Referring to FIG. 1, an illustrative computer system 100 is shown for implementing the preferred system and method for monitoring the status of items subject to liens (“Central Tracker”). Computer system 100 may be a general-purpose computer, special purpose computer, or other programmable data processing apparatus to produce a machine. Computer system 100 preferably includes at least a processor 106, memory 104, input/output (“I/O”) interface 105, storage device 102, and network interface 107, all which operate in a conventional manner.

In the preferred embodiment, a central tracker 101 allows for the implementation of the functions/acts specified in the subsequent disclosure, flowcharts, and block diagrams by preferably loading from storage device 102 into memory 104 and having its instructions executed by processor 106. The central tracker 101 is shown to be stored as a file containing a series of computer program instructions in storage device 102. Storage device 102 is preferably a hard disk, but may be a computer diskette, optical storage device or any other tangible medium suitable for storing, communicating, propagating, and/or transporting the central tracker program instructions 101. Storage device 102 may also include item database 108. Item database 108 may be any conventional database (e.g., Oracle, Sybase, etc.). As will be discussed further below, item database 108 may store item related information and may receive item related data from an ownership registering authority.

Central tracker 101 may be part of the operating system for best efficiency. Alternatively, the operating system may invoke one or more separate software applications to employ the central tracker 101. One skilled in the art will recognize that an implementation of an actual computer may contain additional components and that FIG. 1 contains a high level representation of some of the components of such a computer for illustrative purposes.

It is understood that the disclosed system and method may be embodied using conventional hardware components or by using any combination of one or more software languages (e.g., Java, C++, C, etc.). Alternatively, the disclosed system and method may be embodied using a combination of both hardware and software.

An entirely software embodiment of the disclosed system and method may include firmware, resident software, microcode, etc., and may take the form of computer program instructions embodied in any tangible medium of expression. Computer-readable medium may include (a non-exhaustive list): an electrical connection having one or more wires, a portable computer diskette, a hard disk, a random access memory (“RAM”), a read-only memory (“ROM”), an erasable programmable ROM (e.g., EPROM or Flash memory), an optical fiber, a portable compact disc ROM, an optical storage device, a transmission media such as those supporting the Internet or an intranet, or a magnetic storage device. It should be noted that the computer-usable or computer-readable medium may even be paper or other suitable mediums upon which a program instructions may be printed, since the program instructions can be electronically captured via, for example, optical scanning of the paper or other medium, then compiled, interpreted, or otherwise processed in a suitable manner, if necessary, and then stored in a computer memory.

The computer-usable program code may be embodied within a propagated data signal, either in base band or as part of a carrier wave. The computer usable program code may be transmitted using any suitable means, including, but not limited to, wireless, wire line, optical fiber cable, radio frequency (“RF”), etc.

As noted above, the disclosed system and method may be written using any combination of one or more software languages. The program code may execute entirely on the user's computer, partly on the user's computer, as a stand-alone software package, partly on the user's computer and partly on a remote computer, or entirely on a remote computer. When executing on a remote computer, the remote computer may be connected to the user's computer using conventional networking models (e.g., local area network (“LAN”), wide area network (“WAN”), etc.). The flowchart illustrations disclosed in this application contain blocks that may be executed using computer-programming instructions.

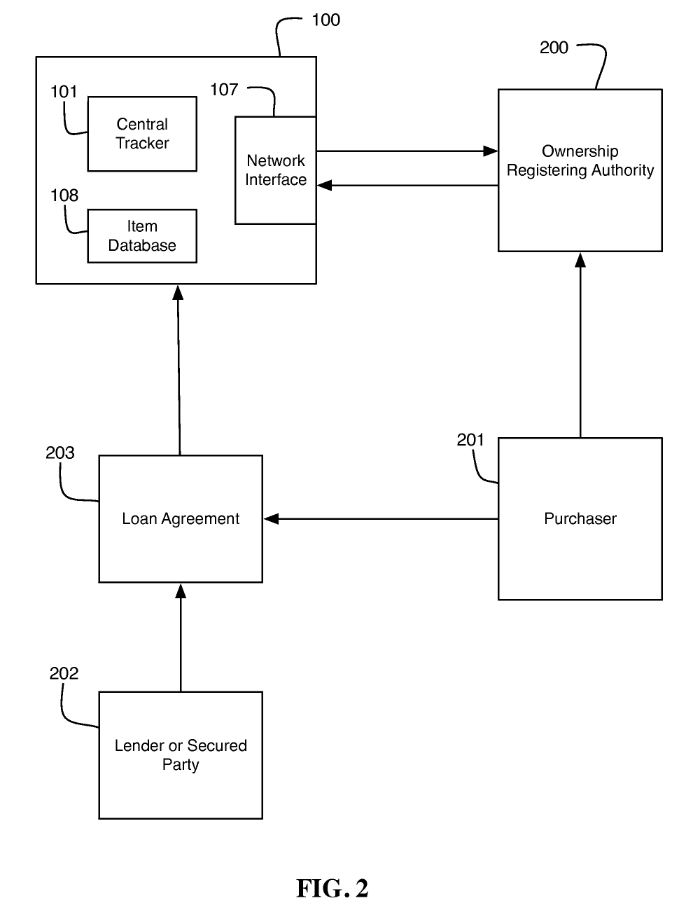

Referring to FIG. 2, a preferred network arrangement for monitoring the status of items subject to liens is shown. In one embodiment, in a method for a monitoring the status of items subject to liens status, lender or secured party 202 may register a lien or security interest in an item in the central tracker 101 executing on computer system 100. The items registered with the central tracker 101 may be stored in item database 108. The central tracker 101 may access data from an ownership registering authority 200. Central tracker 101 may access the data from the ownership registering authority 200 via network interface 107 using conventional networking protocols (e.g., TCP/IP, SMTP, FTP, etc.). Central tracker 101 may contain additional instructions to validate the data received from the ownership registering authority 200 and to confirm the status of each item in the central tracker's item database 108. If the data from the ownership registering authority 200 shows a change in the status of the item, the purchaser 201 and/or lender 202 may be notified of the change.

An item may be any item subject to a security interest. This may include vehicles, such as, for example, cars, trucks, motorcycles, boats, industrial equipment, buildings and structures, and property. A purchaser 201, using financing obtained in loan agreement 203 between purchaser 201 and lender 202, may purchase the item. The purchaser 201 may be any party capable of entering into a loan agreement 203 and affecting the purchase of the item. For example, the purchaser 201 may be an individual making a purchase for personal use or purchasing on behalf of an organization, such as, for example, a car dealership. The lender 202 may be any party capable of providing a loan to the purchaser 201 for the purchase of the item, such as, for example, an individual, a bank, or any other type of financial organization. The loan agreement 203 may be any agreement between the purchaser 201 and the lender 202 containing the terms of the loan from the lender 202 to the purchaser 201, and may include one or more documents. For example, the loan agreement 203 may be part of, or a supplement to, a conditional sale contract. The loan agreement 203 may establish a lien or security interest on the part of the lender 202 in the item being purchased with the loan. For example, the loan agreement 203 may establish a PPSA security interest in the item, which may be perfected by the lender 202 according to Canadian law or the law of the relevant jurisdiction. The lender 202 may also transfer the loan, along with the security interest in the item, to another party, making that party the lien-holder or secured party. The purchaser 201 may register its ownership of the item with the appropriate ownership registering authority 200 in the jurisdiction in which the item was purchased.

For example, the purchaser 201 of a car in Canada may sign a conditional sale contract with a bank 202. The bank 202 may then lend the purchase price of the car to the purchaser 201, who may use the money to buy the car. The bank 202 may perfect a PPSA security interest in the car to become a secured party, and the purchaser 201 may register ownership of the car at the PMT associated with the province where the purchaser 201 is located.

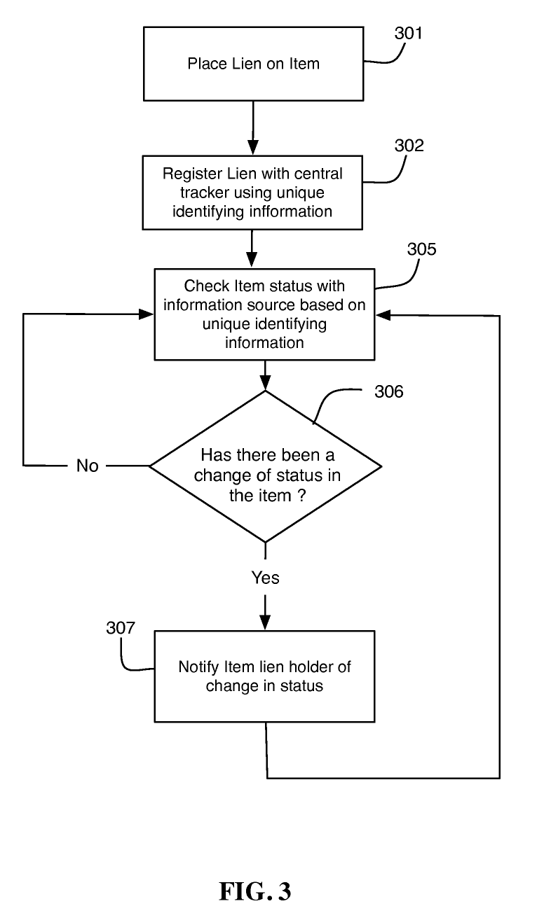

FIG. 3 illustrates a preferred sequence of steps for monitoring the status of items subject to liens. After placing a lien on an item in step 301, the lender 202 may register the lien or security interest with central tracker 101 in step 302. As stated above, central tracker 101 is preferably a series of computer program instructions executing on any computer or computer system 100 capable of storing information on items in an item database 108 and acquiring/receiving data from an ownership registering authority 200. While the central tracker 101 is illustrated as a series of computer instructions, it is understood that central tracker 101 may be solely a hardware embodiment or a combination of software and hardware. For example, the central tracker 101 may be a server farm connected to an ownership registering authority 200 via a network connection, such as, for example, the Internet. The lien or security interest may be registered with the central tracker 101 by the lender 202 using any suitable means, such as, for example, a separate computer application connected to central tracker 101 using conventional networking protocols (e.g., TCP/IP, SMTP, FTP, etc.). The lender 202 may use a separate computer or computer system connected via a network to the central tracker 101 to register the lien or security interest electronically. Alternatively, the lender 202 may notify an operator of the central tracker 101 by phone, mail, e-mail or any other means of communication, of the lien or security interest. The operator may then manually register the lien with the central tracker 101.

The item may be identified in the central tracker's item database 108 using any suitable and unique identifying information. For example, a vehicle may be identified in the item database 108 using the Vehicle Identification Number (“VIN”) associated with the vehicle. Non-unique information about the item may also be stored in database 108 along with the unique identifying information. For example, a vehicle's make, model, year, and color may be stored in the item database 108 along with the vehicle's VIN. The item database 108 may also include information identifying the purchaser 201 and the lender 202 responsible for registering the item with the central tracker 101. Information pertaining to the lien or secured interest itself may also be included, such as, for example, the terms of the loan agreement 203 that established the lien or security interest, and the current status of the lien or security interest such as, for example, whether the item is still encumbered by the lien or security interest.

The central tracker 101 may search the item database 108 using the item's unique identifying information to determine whether the item has already been registered by another lender, lien-holder, or otherwise secured party holding a previous lien or security interest. If the central tracker 101 determines another lender has registered the item, the central tracker 101 may determine whether the item is still encumbered by the previous lien. If so, the central tracker 101 may notify the lender, lien holder or secured party 202 not to provide the purchase price to the purchaser 201 until the previously established lien or security interest is removed from the item. The notification may be implemented as a pop-up window, a voice message, e-mail, or any other suitable means of electronic notification using, for example, I/O interface 105 or network interface 107.

For example, after making the loan to the car purchaser 201 and acquiring a security interest in the vehicle, the bank 202 may register the security interest with the central tracker 101. The item database 108 of the central tracker 101 may be searched for the VIN of the car. If the car is not found in the item database 108, or is found but has no encumbering liens or security interests, the car may be registered with the central tracker 101. The VIN of the car, other information identifying the car, the identities of the purchaser 201 and the bank, the terms of the loan agreement 203, and the status of the security interest encumbering the car, may all be stored in an entry for the car in the item database 108 of the central tracker 101.

Once an item has been registered in the central tracker 101 in step 302, the central tracker 101 may monitor the status of the item in step 305. The central tracker 101 may acquire or receive data pertaining to the status of the item from an appropriate ownership registering authority 200, using the unique identifying information for the item. The ownership registration authority 200 used by the central tracker 101 for each item may depend on the type of item and the jurisdiction in which the item was sold. For example, the ownership registering authority 200 for a car sold in Canada is the PMT. The central tracker 101 may acquire or receive data for the item by any suitable means, such as, for example, querying an ownership registration authority 200 controlled computer database, querying a third party controlled computer database containing information from the ownership registering authority 200, or through manual acquisition and entry of the information into the central tracker 101.

The central tracker 101 may, for example, request records from PMT computer systems, or third party computer systems such as, for example, those operated by CARFAX, Inc., for the car in which the bank 202 has a security interest, based on the car's VIN. Use of the car's VIN may ensure that the records for the proper car are obtained, as the VIN may be unique to the vehicle.

In step 306, the data obtained from the ownership registering authority 200 may be analyzed by the central tracker 101 or by a separate computer system with access to data from database 108 used by the central tracker 101 to determine if there has been a change in the status of the item. Changes in the status of the item may include a change in the ownership of the item as reported to the ownership registration authority 202, the reporting of lost ownership registration documents for the item, the issuance of new or additional ownership registration documents for the item, etc.

If the central tracker 101 detects no changes in the status of the item in step 306, the central tracker 101 may continue to the monitor the status of the item in step 305. If, however, a change in the status of the item is detected in step 306, the central tracker 101 may report the change in status in step 307 via a notification sent to the lender 202 responsible for registering the item, or to another party, such as, for example, a loan servicing organization, acting on behalf of the lender 202. The notification may be, for example, an automatically generated e-mail, a computer generated phone call, a notification to an operator of the central tracker 101 to place a phone call, or any other suitable notification, which may result in the lender 202 being notified of the change in status of the item.

The central tracker 101 may continually monitor the status of each item registered item database 108 in step 305. Changes in any item's status may be detected in step 306 and notification to the lender 202 may be generated/provided in step 307 within a short time after the change in status takes place at the ownership registering authority 200. For example, if the central tracker 101 has persistent access to the ownership registering authority 200, via a conventional networking interface, a change in status may be detected in step 306 and a report/notification generated in step 307 only seconds or minutes after the change in status is made at the ownership registering authority 200.

If, for example, the purchaser 201 of the car goes to the PMT, reports a lost ownership registration document, and acquires a new ownership registration document, this may be a detectable change in the car's status. When the central tracker 101 uses the car's VIN, for example, to check the car's status with the PMT in step 305, the central tracker 101 may obtain the PMT records reporting of the lost ownership registration documents associated with the VIN and the issuance of new ownership registration documents. Analysis of this data by the central tracker 101 may result in a determination that the car's status has changed in step 306, and an e-mail, facsimile or other communication may be automatically sent to the bank 202 in step 307 notifying the bank of this change in the status of the car. This information may be pre-screened by a Customer Service Representative (CSR) working on behalf of the central tracker and the bank, who investigates and resolves alerts on behalf of the bank. The bank, or the CSR, may then take appropriate action, such as, for example, contacting the purchaser 201 of the car to determine if the purchaser 201 is attempting to, or has already, sold the car out of trust. If the purchaser 201 has sold the car out of trust, the bank may be able to request immediate payment of a balloon payment, before the purchaser 201 can obtain bankruptcy protection, or reverse the sale, even if the second purchaser was a bona fide purchaser for value without notice, due to having been notified of the change in the status of the car in a timely manner.

In addition to the ownership registering authority 200, the central tracker 101 may acquire or receive data on the status of the item from other available sources of information, and analyze this data for changes in the status of the item. For example, the central tracker 101 may acquire or receive data from any number of insurers, to ascertain whether or not the item is insured, and, if it is, the party providing the insurance, the type of insurance, and any other terms of the insurance agreement that may be available. The central tracker 101 may monitor the other sources of information in the same way the central tracker 101 monitors the ownership registering authority 200 in step 305, allowing any change in the status of the item reported in any of the other sources of information to be reported promptly to the lender 202 in step 307. For example, if the purchaser 201 is required to maintain insurance on the secured item, the entry in the item database 108 of the central tracker 101 for the item may include the insurance information. The central tracker 101 may use the insurance information in step 302 to monitor the status of the item in the appropriate source of information, for example, the computer database belonging to the party providing the insurance. The central tracker 101 may analyze data acquired or received from the party providing the insurance in step 306, and notify the lender 202 in step 307 if, for example, the purchaser 201 cancels the insurance and there is no notification from the purchaser 201 to the central tracker 101 of the purchase of new insurance to ensure the continuity of insurance coverage.

Further, information on the item in the item database 108 on the central tracker 101 may be made accessible to interested parties. The interested party may be any party with some desire to acquire information about the item, such as, for example, a potential purchaser. The interested party may be granted access to any or all of the information on an item contained in the item database 108, at the preference of the operator of the central tracker 101. The central tracker 101 may be searched directly by an interested party using, for example, unique identifying information for an item, or using non-unique identifying information. The central tracker 101 may also be searched on behalf of an interested party by another service, such as, for example, an Internet search service. Information from the central tracker's item database 108 may also be provided by the central tracker 101 to a third party, for incorporation into reports provided by the third party.

For example, a person shopping for a car using an Internet search service, such as, for example, www.cars.com may be presented with a list of cars after conducting a search on the service. The cars for sale that are the results of the search may be displayed with information pertaining to the sale of each car, such as, for example, sale price, mileage, make, model, and year of each car, etc. If the search service has been granted access to the central tracker 101, information from the item database 108 of the central tracker 101 may also be displayed for each car that is in the item database 108. This information may be provided directly to the search service, which may incorporate the information into its own databases, or may be provided by conducting a search of the central tracker 101 for the VIN of each car found as a result of the search by the person using the search service. The information that may be displayed may include whether or not the car is encumbered by a lien or security interest.

As another example, a person shopping for a car may obtain a report on a particular car's history through a CARFAX report obtained from CARFAX, Inc. CARFAX, Inc. may be granted access to the central tracker 101, and information from the item database 108 of the central tracker 101 may be obtained based on a car's VIN and incorporated into the car's CARFAX report. For example, if the car is encumbered by a lien or security interest, the CARFAX report may indicate that the car is VIN locked. This may serve to alert a potential purchaser of the car that the potential purchaser should not buy the car until the lien or security interest on the car has been removed, either through the paying off of the lien or security interest, or through the removal of an already paid off lien or security interest by the lender 202.

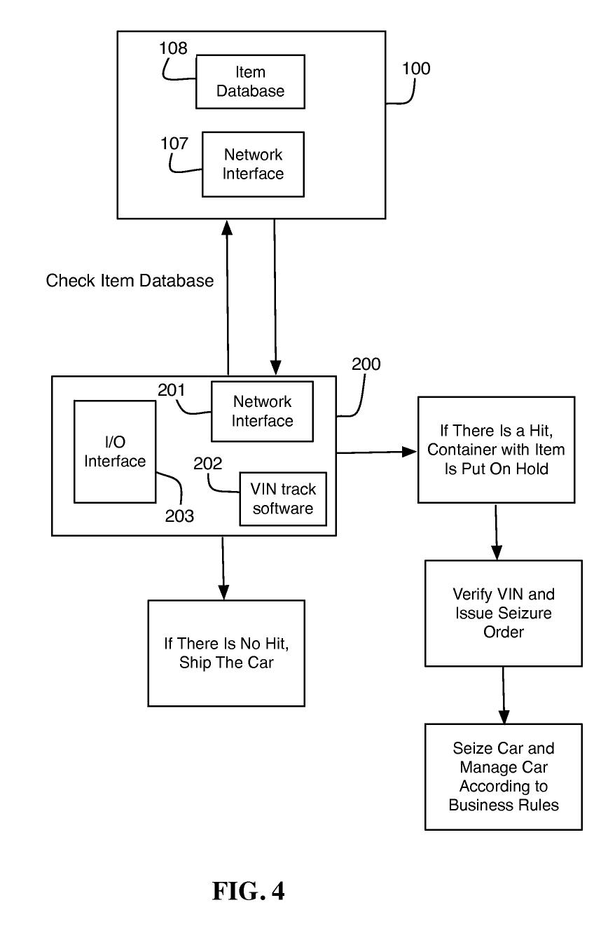

FIG. 4 is a block diagram illustrating an exemplary network arrangement allowing a port management facility, Border Control Police Authorities, or other third party to utilize information maintained in the item database 108 to restrict items (e.g., automobiles) subject to liens from being shipped overseas. The item may, for example, be an automobile located within a cargo container.

Port facility computer 200 may execute VIN tracking software/program instructions 202 that interface with the item database 108 over a network, such as, for example, the Internet, by creating a network session between network interface 201 and network interface 107 of central tracker computer system 100. The administrator of the VIN tracking software may be provided with a valid username and password that allows VIN tracking software 202 to log in and query item database 108. The administrator may enter a VIN number or other unique identifier via an I/O device (e.g., keyboard, scanner, voice recognition software, etc.) suitable for interfacing with I/O interface 203.

VIN tracking software 202 may transmit a query using conventional database query language (e.g., standard query language) using the entered VIN number or other unique identifier as a parameter. Item database 108 may index automobile information by VIN number, which is a standard unique identifier for automobiles, or any other unique identifier. If a record from item database 108 is identified in response to the query, the automobile may be held at the port or other location where a bailiff or customs official may verify the VIN and issue a seizure order. After the automobile is seized, the vehicle may be managed according to business rules. The business rules may require, for example, transporting the automobile to the nearest dealership, cleaning and auctioning the automobile, or selling the automobile on consignment. If the query does not return a record from the item database 108, the automobile may be allowed to embark on a cargo vessel for overseas delivery.

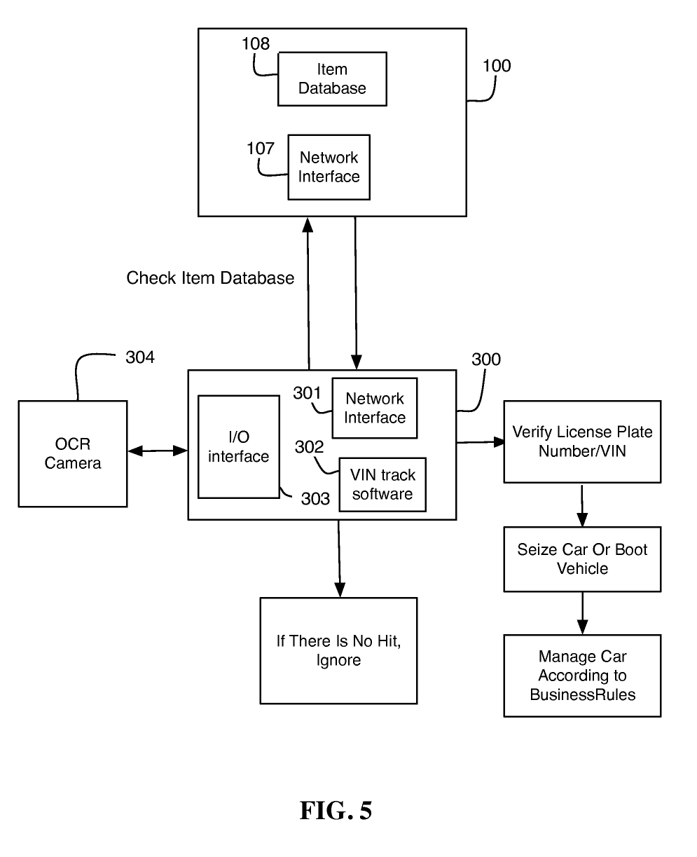

FIG. 5 illustrates an exemplary network configured to provide a bailiff, police officer or third party access to item database 108 to identify items (e.g., automobiles) that are uninsured or whose owners are in default in paying a loan secured by the item. A conventional optical character recognition (“OCR”) camera 304 may, for example, be mounted on a vehicle operated by a bailiff, police officer, or third party to read license plates on automobiles driving or parked on public streets. Alternatively, the OCR camera 304 may be mounted at an intersection, toll collection booth, or other location to capture the license plates of vehicles on a roadway.

The OCR camera 304 is preferably connected in a conventional manner (directly or via wireless technology) to a computer 300 using I/O ports coupled to I/O interface 303. Computer 300 may execute software that allows computer 300 to interface with OCR camera 304. The computer 300 may, for example, be mounted in the vehicle operated by the bailiff, police officer, or third party.

The OCR camera 304 may capture the license plate of an automobile passing in front of the camera, which license plate is read by the computer 300 using OCR software executing on the computer's processor. Alternatively, a bailiff/officer may enter the license plate via a keyboard, voice recognition software, or any other device suitable for entering data via I/O interface 303.

The computer 300 preferably includes a processor and memory to execute VIN tracking software/program instructions 302 to interface with the item database 108 of central tracker computer system 100 over a network, such as, for example, the Internet, by creating a network session between network interface 301 and network interface 107 of central tracker computer system 100. VIN tracking software 302 may transmit a query to item database 108 using conventional database query language (i.e., standard query language).

After the OCR camera 304 captures the license plate from an automobile, OCR software executing on computer 300 reads the license plate number and stores the number in memory. VIN tracking software 302 executing on computer 300 may then use this license plate number as a parameter in a query transmitted to item database 108, which may be encoded using conventional database query language.

Item database 108 may index automobile information by license plate number, as well as by VIN number. In addition, as noted above, central tracker computer system 100 may also receive and maintain item insurance status information from insurers. This data may allow third parties to determine whether an item, such as an automobile, currently has insurance coverage and whether the owner of the automobile is in default on a loan secured by the vehicle.

Item database 108 may acknowledge the query with a record corresponding to the license plate number, if one exists. The record may contain lien and/or insurance information. The user of computer 300 may view this information on a graphic user interface. If no record is found, the user of computer 300 may ignore the automobile. If a record identified in response to the query to the item database 108 reveals that the automobile is uninsured or that the owner of the automobile is in default on a loan secured by the vehicle, the bailiff, police officer or other user may manually verify the automobile's license plate number and/or VIN number prior to seizing and/or booting the vehicle. If the automobile is seized, the vehicle may be managed according to business rules, which may require, for example, transporting the automobile to the nearest dealership, cleaning and auctioning the automobile, or selling the automobile on consignment.

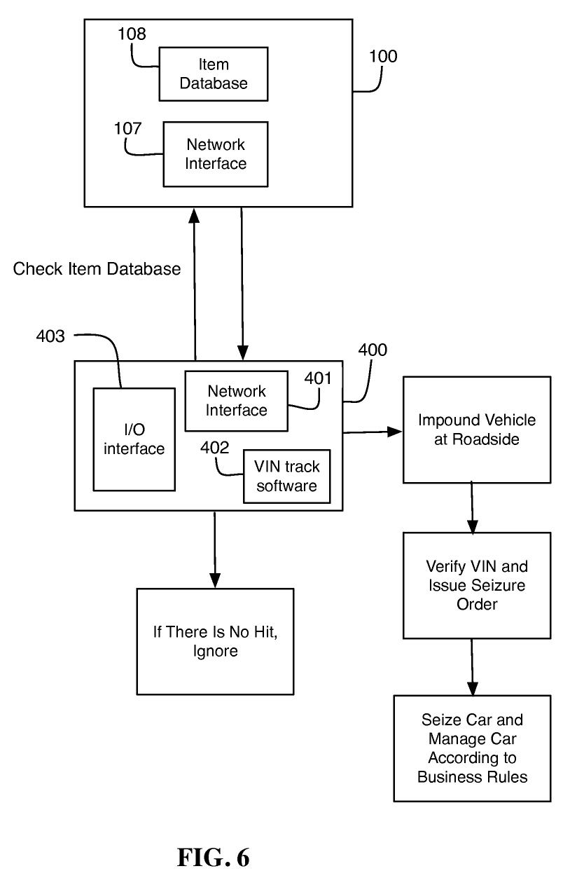

FIG. 6 is a block diagram illustrating an exemplary network arrangement allowing a police officer to confirm insurance status of an automobile during a traffic stop. This may be beneficial since paper copies of insurance may not always be authentic. A computer 400 is preferably mounted in a police car. Computer 400 preferably includes at least a processor, memory, a network interface 401 and an I/O interface 403. VIN tracking software/program instructions 402 executing on the processor of computer 400 facilitates communication between computer 400 and central tracking computer system 100 over a network, such as, for example, the Internet. Network interface 401 initiates the network session over the network with network interface 107 of computer 100.

During a traffic stop, for example, a police officer may enter a license plate number and/or VIN number, or scan a bar code on the proof of insurance slip, for the vehicle in question into computer 400 via an I/O device (i.e., a keyboard, a camera, a voice recognition device, bar code scanner, etc.) suitable for interfacing with I/O interface 403. Computer 400 preferably stores the license plate number, the proof of insurance slip, and/or VIN number in memory and the VIN tracking software 402 uses the license plate number, the proof of insurance slip, and/or VIN number as a parameter in a query transmitted to item database 108. This query may also be encoded using conventional database query language.

Item database 108 may index vehicle information by license plate number, as well as by VIN number. In addition, as discussed above, central tracker computer system 100 may also receive and maintain item insurance status information from insurers. This data may allow third parties, such as a police department, to determine whether an automobile currently has insurance coverage.

Item database 108 may acknowledge the query with a record corresponding to the license plate number and/or VIN number, if one exists. The record may contain insurance information regarding the vehicle in question. A police officer using computer 400 may view this information on a graphic user interface. If no record is found or if the record indicates that the vehicle is insured, the officer may move on to other inquiries or release the driver. On the other hand, if a record is identified indicating that the vehicle is not insured, the officer may impound the vehicle at the roadside. The officer may manually confirm that the license plate and/or VIN number in the record matches that of the vehicle and, in some instances, a seizure order may be issued. If the vehicle is seized, the vehicle may be managed according to business rules, which may require, for example, transporting the automobile to the nearest dealership, cleaning and auctioning the automobile, or selling the automobile on consignment.

In another embodiment, the central tracker 101, and an operator of the central tracker 101, may act as a go-between for the removal of liens or security interests from items in the item database 108. If a second purchaser wishes to buy an item from an original purchaser 201 that has been registered with the central tracker 101, the central tracker 101 may show that the item is encumbered with a lien or security interest held by a lender 202. The original purchaser 201 may still owe money to the lender 202 on the loan used to purchase the item. Instead of paying the remainder of the loan to the lender 202 directly, the original purchaser 201 may pay the money, for example, in trust, to the operator of the central tracker 101. The operator of the central tracker 101 may remove the encumbrance of the lien or security interest from the item on receipt of the payment from the original purchaser 201, allowing the original purchaser 201 to sell the item to the second purchaser. The central tracker 101 may transfer the money from the original purchaser 201 to the lender 202. This may allow for the encumbrance of the lien or security interest to be removed from the item faster than if the original purchaser 201 had paid the money to the lender 202, as there is no waiting period while the lender 202 processes the transaction and notifies the central tracker 101 that the lien or security interest should be removed. Instead, the lien or secured interest may be removed from the item quickly, as soon as the operator of the central tracker 101 verifies that the original purchaser 201 has transferred the money to pay off the remainder of the loan.

For example, an original purchaser 201 may purchase a car with a loan from a bank. The bank may establish a security interest in the car, and register the car with a central tracker 101. The original purchaser 201 may then seek to sell the car to a second purchaser while there is still $15,000 left on the loan from the bank to the original purchaser 201. The original purchaser 201 may transfer $15,000, in trust, to the operator of the central tracker 101. Once the operator of the central tracker 101 verifies receipt of the $15,000, the car's entry in the item database 108 of the central tracker 101 may be updated to reflect that the car is no longer encumbered by the bank's security interest. The original purchaser 201 may proceed with selling the car to the second purchaser, and the operator of the central tracker 101 may transfer the $15,000 to the bank.

The flowchart and block diagrams in the figures illustrate the architecture, functionality, and operation of possible implementations of systems, methods and computer program products according to various embodiments of the central tracker 101. In this regard, each block in the flowchart or block diagrams may represent a module, segment, or portion of the central tracker 101 code, which comprises one or more executable instructions for implementing the specified logical function(s). As will be appreciated by one skilled in the art, in some alternative implementations, the functions noted in the block may occur out of the order illustrated in the figures. For example, two blocks shown in succession may, in fact, be executed substantially concurrently, or the blocks may sometimes be executed in the reverse order, depending upon the functionality involved. It is also understood that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A computer-implemented method for monitoring the status of an item subject to a lien, comprising:
receiving registration information associated with the item subject to the lien, including at least one identifier uniquely associated with the item;
storing the registration information in a record associated with the item within an item database;
receiving data about the item over a communications network from at least one information source based on the unique identifier associated with the item;
comparing the received data to the stored registration information to determine whether the status of the item has changed;
updating the database record to reflect a change in status of the item; and
automatically generating a notification to a holder of the lien when the status of the item has changed.

2. The computer-implemented method according to claim 1, further comprising:
determining whether the item is encumbered by a preexisting lien by using the unique identifier associated with the item to search records stored in the item database for a record corresponding to the item; and
generating a notification that the item is encumbered by a preexisting lien if the search of the database records identifies a record corresponding to the item.

3. The computer-implemented method according to claim 2, further comprising notifying a lender not to provide a loan to a purchaser of the item until the preexisting lien on the item is removed.

4. The computer-implemented method according to claim 2, further comprising verifying that the preexisting lien has been satisfied before updating the record associated with the item to remove the preexisting lien as an encumbrance to the item.

5. The computer-generated method according to claim 4, further comprising receiving payment in trust of an outstanding balance of a loan owed to the holder of the preexisting lien before updating the record associated with the item to remove the preexisting lien as an encumbrance to the item.

6. The computer-implemented method according to claim 5, further comprising transferring the received payment to the holder of the preexisting lien.

7. The computer-implemented method according to claim 1, wherein the data is received from an ownership registration authority database.

8. The computer-implemented method according to claim 1, wherein the data is received from an insurance company database.

9. The computer-implemented method according to claim 1, wherein the status of the item has changed when comparison of the received data to the stored record indicates at least one of the following: a change in ownership of the item, reporting of lost ownership registration documents for the item, issuance of new ownership registration documents for the item, issuance of additional ownership registration documents for the item, or a change in insurance for the item.

10. The computer-implemented method according to claim 1, wherein the notification comprises at least one of the following: a computer generated email, facsimile, text message or voice message,

11. The computer-implemented method according to claim 1, wherein the status of the item in the database is accessible by a third party over a communications network.

12. The computer implemented method according to claim 11, wherein a query to the database is received from a third party over the communication network with a unique item identifier.

13. The computer implemented method according to claim 12, wherein the unique item identifier is a vehicle identification or license plate number of a vehicle.

14. The computer implemented method according to claim 13, wherein the query requests lien status information or insurance status information from the database.

15. The computer implemented method according to claim 14, wherein the third party is a port management facility that seizes the vehicle when the database reply to the query confirms that the vehicle is subject to a lien.

16. The computer implemented method of claim 14, wherein the vehicle is seized when the database reply to the query confirms that the vehicle is subject to a lien.

17. The computer implemented method according to claim 14, wherein the third party is a police officer who seizes the vehicle when the database reply to the query confirms that the vehicle is not insured.

18. A system for monitoring the status of item subject to liens, comprising:
a computer processor;
an item database operatively connected to the processor, the item database containing a record associated with each item subject to a lien;
a network interface operatively connected to the processor for communicating over a communications network;
a memory operatively connected to the processor, the memory containing a program having computer readable commands, wherein the computer readable commands instruct the processor to:
receive registration information associated with an item subject to a lien, including at least one identifier uniquely associated with the item;
store the registration information in a record associated with the item within the item database;
receive data about the item over the communications network from at least one information source based on the unique identifier associated with the item;
compare the received data to the stored registration information to determine whether the status of the item has changed;
update the database record to reflect a change in status of the item; and
automatically generate a notification to a holder of the lien when the status of the item has changed.

19. The system according to claim 18, wherein the computer readable commands instruct the processor to:
search records stored in the item database for a record corresponding to the item using the unique identifier associated with the item to determine whether the item is encumbered by a preexisting lien; and
generating a notification that the item is encumbered by a preexisting lien if the search of the database records identifies a record corresponding to the item.

20. The system according to claim 19, wherein the computer readable commands instruct the processor to notify a lender not to provide a loan to a purchaser of the item until the preexisting lien on the item is removed.

21. The system according to claim 19, wherein the computer readable commands instruct the processor to verify that the preexisting lien has been satisfied before updating the record associated with the item to remove the preexisting lien as an encumbrance to the item.

22. The system according to claim 21, wherein the computer readable commands instruct the processor to update the record associated with the item to remove the preexisting lien as an encumbrance to the item upon receiving payment in trust of an outstanding balance of a loan owed to the holder of the preexisting lien.

23. The system according to claim 22, wherein the computer readable commands instruct the processor to transfer the received payment to the holder of the preexisting lien.

24. The system according to claim 18, wherein the data is received from an ownership registration authority database.

25. The system according to claim 18, wherein the data is received from an insurance company database.

26. The system according to claim 18, wherein the status of the item has changed when comparison of the received data to the stored record indicates at least one of the following: a change in ownership of the item, reporting of lost ownership registration documents for the item, issuance of new ownership registration documents for the item, issuance of additional ownership registration documents for the item, or a change in insurance for the item.

27. The system according to claim 18, wherein the notification comprises at least one of the following: a computer generated email, facsimile, text message, or voice message,

28. The system according to claim 18, wherein the status of the item in the database is accessible by a third party over the communications network.

29. The system according to claim 28, wherein a query to the database is received from a third party over the communication network with a unique item identifier.

30. The system according to claim 29, wherein the unique item identifier is a vehicle identification or license plate number of a vehicle.

31. The system according to claim 30, wherein the query requests lien status information or insurance status information from the database.

32. The system according to claim 31, wherein the third party is a port management facility that seizes the vehicle when the database reply to the query confirms that the vehicle is subject to a lien.

33. The system of claim 31, wherein the vehicle is seized when the database reply to the query confirms that the vehicle is subject to a lien.

34. The system according to claim 31, wherein the third party is a police officer who seizes the vehicle when the database reply to the query confirms that the vehicle is not insured.

35. A system for monitoring the status of an item subject to a lien, comprising:
means for receiving registration information associated with the item subject to the lien, including at least one identifier uniquely associated with the item;
means for storing the registration information in a record associated with the item within an item database;
means for receiving data about the item over a communications network from at least one information source based on the unique identifier associated with the item;
means for comparing the received data to the stored registration information to determine whether the status of the item has changed;
means for updating the database record to reflect a change in status of the item; and
means for automatically generating a notification to a holder of the lien when the status of the item has changed.

36. The system according to claim 35, further comprising:
means for determining whether the item is encumbered by a preexisting lien by searching records stored in the item database for a record corresponding to the item using the unique identifier associated with the item; and
means for generating a notification that the item is encumbered by a preexisting lien when the search of the database records identifies a record corresponding to the item.

37. The system according to claim 36, wherein a lender is automatically notified not to provide a loan to a purchaser of the item until the preexisting lien on the item is removed.

38. The system according to claim 36, further comprising means for verifying that the preexisting lien has been satisfied before updating the record associated with the item to remove the preexisting lien as an encumbrance to the item.

39. The system according to claim 38, wherein the record associated with the item is updated to remove the preexisting lien as an encumbrance to the item upon receiving payment in trust of an outstanding balance of a loan owed to the holder of the preexisting lien.

40. The system according to claim 39, wherein the received payment is transferred to the holder of the preexisting lien.

41. The system according to claim 35, wherein the data is received from an ownership registration authority database.

42. The system according to claim 35, wherein the data is received from an insurance company database.

43. The system according to claim 35, wherein the status of the item has changed when comparison of the received data to the stored record indicates at least one of the following: a change in ownership of the item, reporting of lost ownership registration documents for the item, issuance of new ownership registration documents for the item, issuance of additional ownership registration documents for the item, or a change in insurance for the item.

44. The system according to claim 35, wherein the notification comprises at least one of the following: a computer generated email, facsimile, text message, or voice message,

45. The system according to claim 35, wherein the status of the item in the database is accessible by a third party over the communications network.

46. The system according to claim 45, wherein a query to the database is received from a third party over the communication network with a unique item identifier.

47. The system according to claim 46, wherein the unique item identifier is a vehicle identification or license plate number of a vehicle.

48. The system according to claim 47, wherein the query requests lien status information or insurance status information from the database.

49. The system according to claim 48, wherein the third party is a port management facility that seizes the vehicle when the database reply to the query confirms that the vehicle is subject to a lien.

50. The system of claim 48, wherein the vehicle is seized when the database reply to the query confirms that the vehicle is subject to a lien.

51. The system according to claim 48, wherein the third party is a police officer who seizes the vehicle when the database reply to the query confirms that the vehicle is not insured.

52. A computer readable medium on which is stored a computer executable program performing a method for monitoring the status of an item subject to a lien, the program instructions comprising:
receiving registration information associated with the item subject to the lien, including at least one identifier uniquely associated with the item;
storing the registration information in a record associated with the item within an item database;
receiving data about the item over a communications network from at least one information source based on the unique identifier associated with the item;
comparing the received data to the stored registration information to determine whether the status of the item has changed;
updating the database record to reflect a change in status of the item; and
automatically generating a notification to a holder of the lien when the status of the item has changed.

53. The computer readable medium according to claim 52, further comprising:
determining whether the item is encumbered by a preexisting lien by using the unique identifier associated with the item to search records stored in the item database for a record corresponding to the item; and
generating a notification that the item is encumbered by a preexisting lien if the search of the database records identifies a record corresponding to the item.

54. The computer readable medium according to claim 53, further comprising notifying a lender not to provide a loan to a purchaser of the item until the preexisting lien on the item is removed.

55. The computer readable medium according to claim 53, further comprising verifying that the preexisting lien has been satisfied before updating the record associated with the item to remove the preexisting lien as an encumbrance to the item.

56. The computer readable medium according to claim 53, further comprising receiving payment in trust of an outstanding balance of a loan owed to the holder of the preexisting lien before updating the record associated with the item to remove the preexisting lien as an encumbrance to the item.

57. The computer readable medium according to claim 56, further comprising transferring the received payment to the holder of the preexisting lien.

58. The computer readable medium according to claim 52, wherein the data is received from an ownership registration authority database.

59. The computer readable medium according to claim 52, wherein the data is received from an insurance company database.

60. The computer readable medium according to claim 52, wherein the status of the item has changed when comparison of the received data to the stored record indicates at least one of the following: a change in ownership of the item, reporting of lost ownership registration documents for the item, issuance of new ownership registration documents for the item, issuance of additional ownership registration documents for the item, or a change in insurance for the item.

61. The computer readable medium according to claim 52, wherein the notification comprises at least one of the following: a computer generated email, facsimile, text message or voice message,

62. The computer readable medium according to claim 52, wherein the status of the item in the database is accessible by a third party over a communications network.

63. The computer readable medium according to claim 62, wherein a query to the database is received from a third party over the communication network with a unique item identifier.

64. The computer readable medium according to claim 63, wherein the unique item identifier is a vehicle identification or license plate number of a vehicle.

65. The computer readable medium according to claim 64, wherein the query requests lien status information or insurance status information from the database.

66. The computer readable medium according to claim 65, wherein the third party is a port management facility that seizes the vehicle when the database reply to the query confirms that the vehicle is subject to a lien.

67. The computer readable medium of claim 65, wherein the vehicle is seized when the database reply to the query confirms that the vehicle is subject to a lien.

68. The computer readable medium according to claim 65, wherein the third party is a police officer who seizes the vehicle when the database reply to the query confirms that the vehicle is not insured.
